(19) United States
(12) Patent Application Publication
(10) Pub. No.: US 2025/0387283 A1
(43) Pub. Date: Dec. 25, 2025

(54) SEA BURIAL COFFIN AND SYSTEM FOR USING THE SAME

(71) Applicants: YU-AN LIU, Zhubei City (TW); Yun-Jun Liu, Zhubei City (TW); Li-Yu Lin, Zhubei City (TW); Qun-You Lin, Zhubei City (TW)

(72) Inventors: YU-AN LIU, Zhubei City (TW); Yun-Jun Liu, Zhubei City (TW); Li-Yu Lin, Zhubei City (TW); Qun-You Lin, Zhubei City (TW)

(21) Appl. No.: 19/247,197

(22) Filed: Jun. 24, 2025

(30) Foreign Application Priority Data
Jun. 24, 2024 (TW) 113123384

(51) Int. Cl. A61G 17/007

(52) U.S. Cl. CPC A61G 17/007

(57) ABSTRACT

The present disclosure provides a sea burial coffin and system using the same, the sea burial system including: a transportation device configured to carry a coffin from land to the water surface, and a coffin, the coffin detachably attached to the transportation device, and a receiving space being defined in the coffin to receive at least one corpse, wherein the coffin is arranged as a hollow grid structure and is capable of being transported onto the water surface and then entirely submerged into the water.

### RELATED APPLICATIONS

This application claims the benefit of priority to Taiwan Patent Application Number 113123384 filed on June. 24th, 2024, in the Taiwan Intellectual Property Administration. The entire contents of the above-identified application are hereby incorporated by reference.

### TECHNICAL FIELD

The present disclosure relates to the technical field of funeral supplies, and in particular, to a sea burial coffin and system for using the same.

### BACKGROUND

At present, cremation is a well-known funeral method. After cremation, most relatives of a corpse will purchase a cemetery to bury ashes of the corpse after burning. However, with an increasing demand for land and a rise in land price, cost of cremation is also becoming higher, which not only increases people's burden, but also occupies land and resources. Therefore, sea burial can solve above problems caused by cremation.

An operating method of the underwater burial method is to scatter the ashes into the ocean. Unfortunately, scattering ashes into the ocean can cause environmental pollution, making the method difficult to be accepted by people. Therefore, it is necessary to design a new sea burial method.

### BRIEF DESCRIPTION OF DRAWINGS

In order to illustrate the technical solution in embodiments of the present invention more clearly, the following briefly introduces accompanying drawings used in the description of the embodiments. Obviously, the accompanying drawings in the following description are only some embodiments of the present invention. Those of ordinary skill in the art can obtain other accompanying drawings from these accompanying drawings without any creative efforts.

FIG. 1 is a perspective view of a sea burial system according to a first embodiment of the present disclosure.

FIG. 2 is an exploded view of a sea burial coffin of the sea burial system shown in

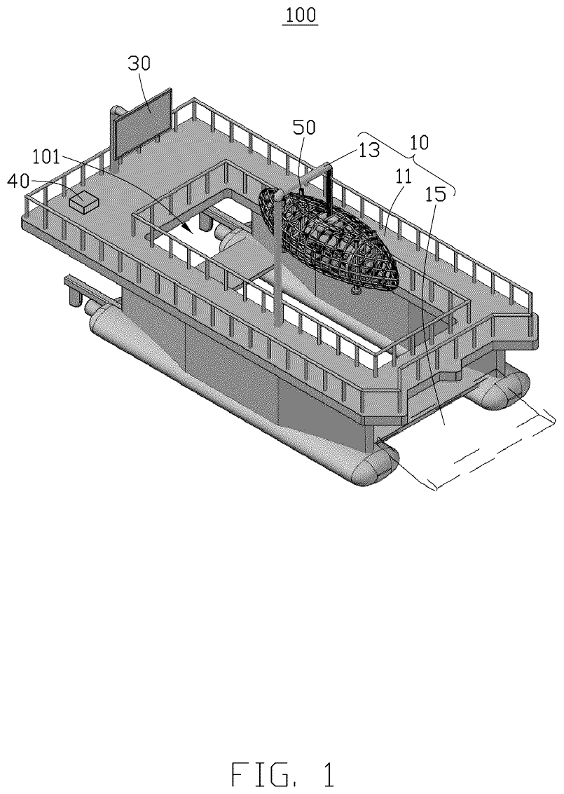

FIG. 1, and the sea burial coffin comprises a casing body, a cover and a lifting mechanism.

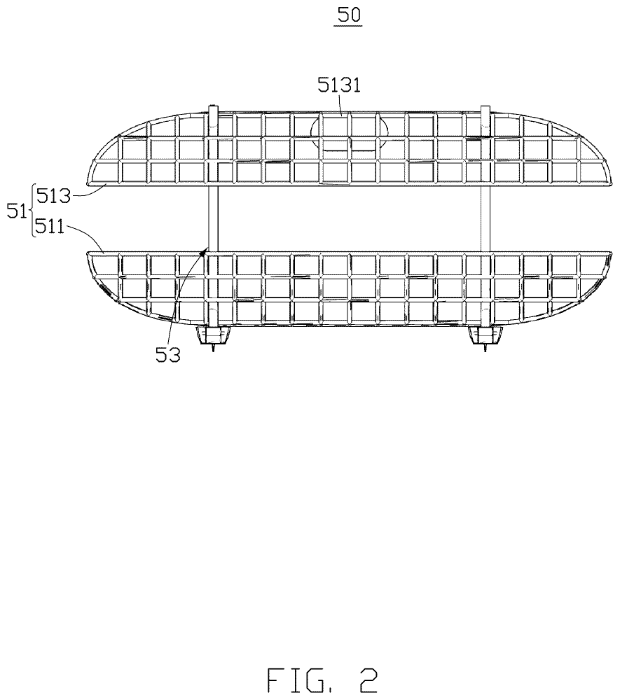

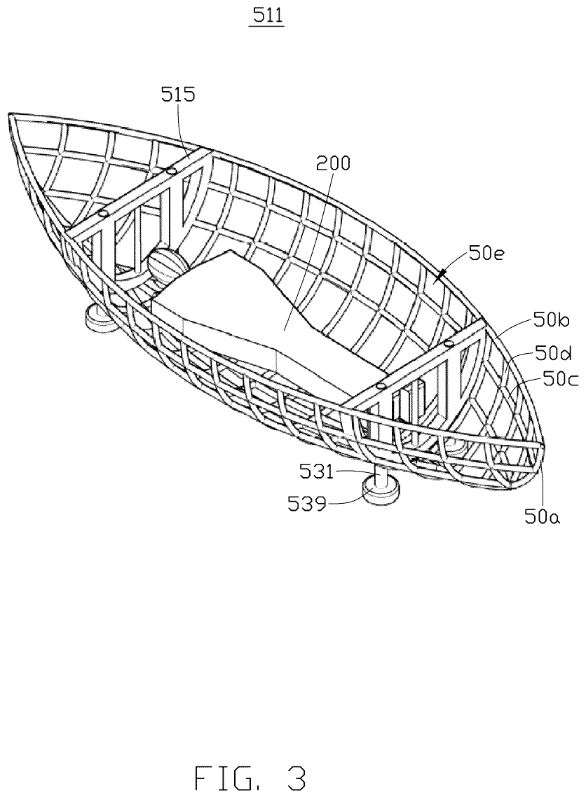

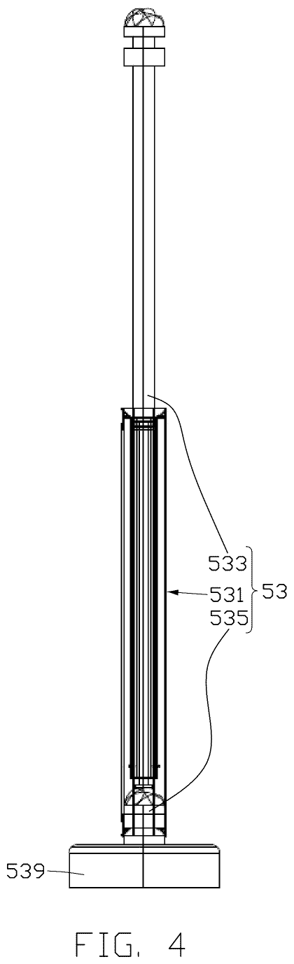

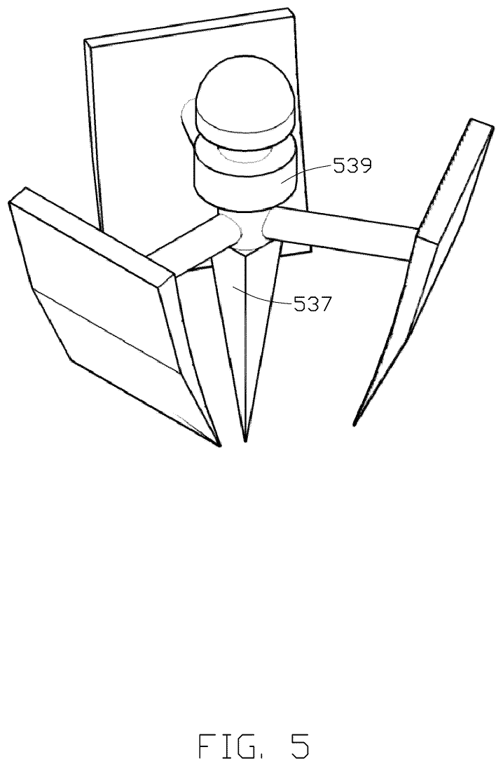

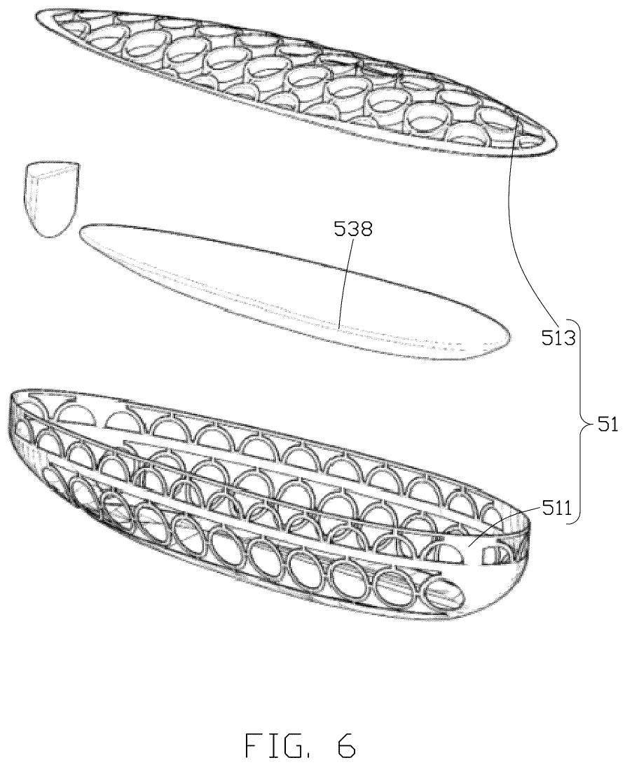

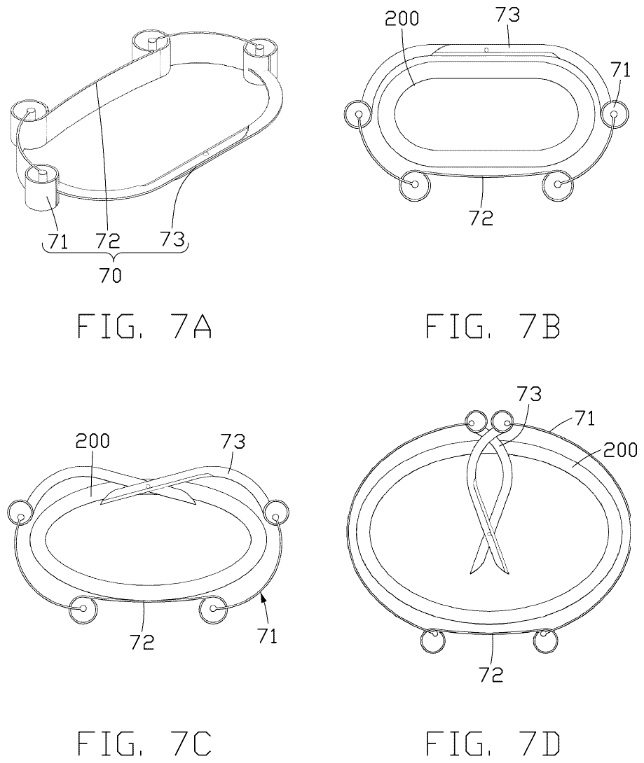

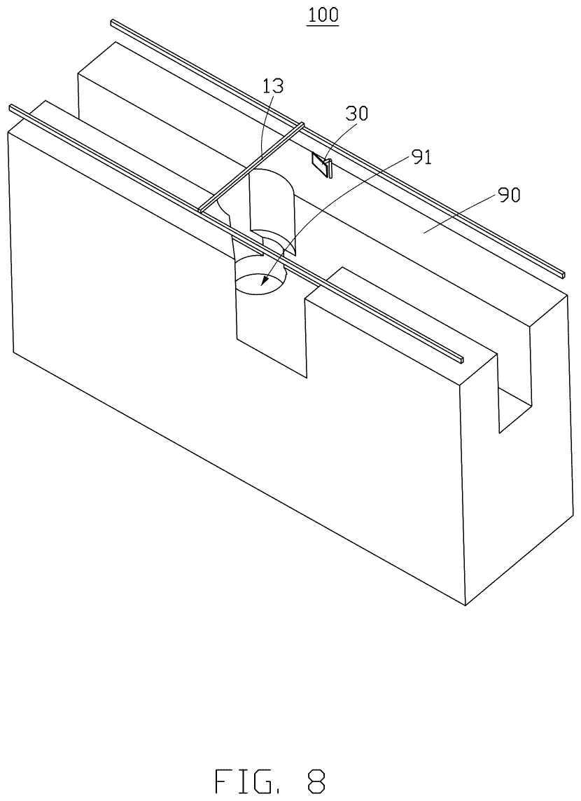

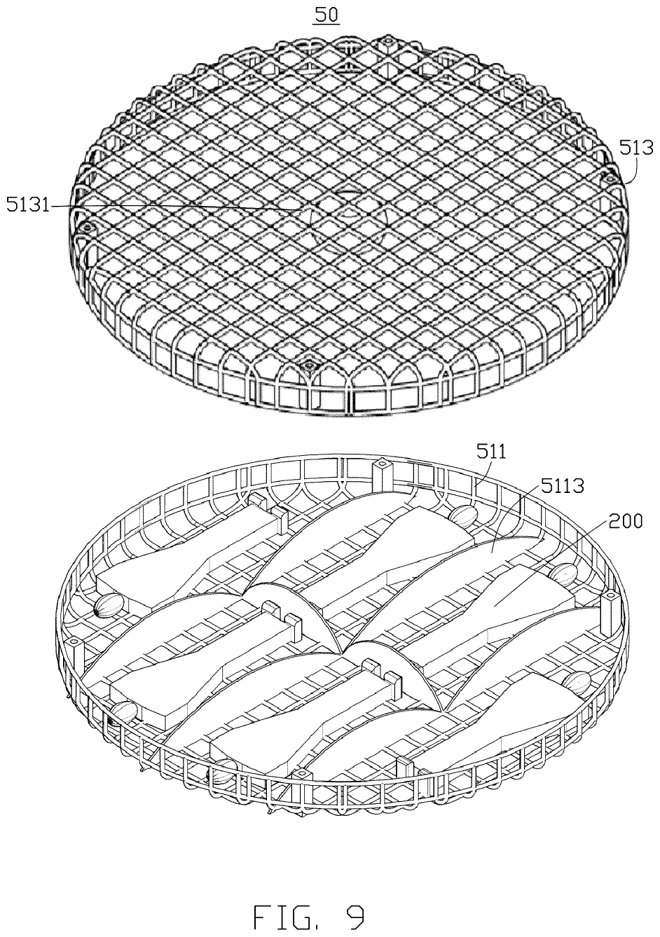

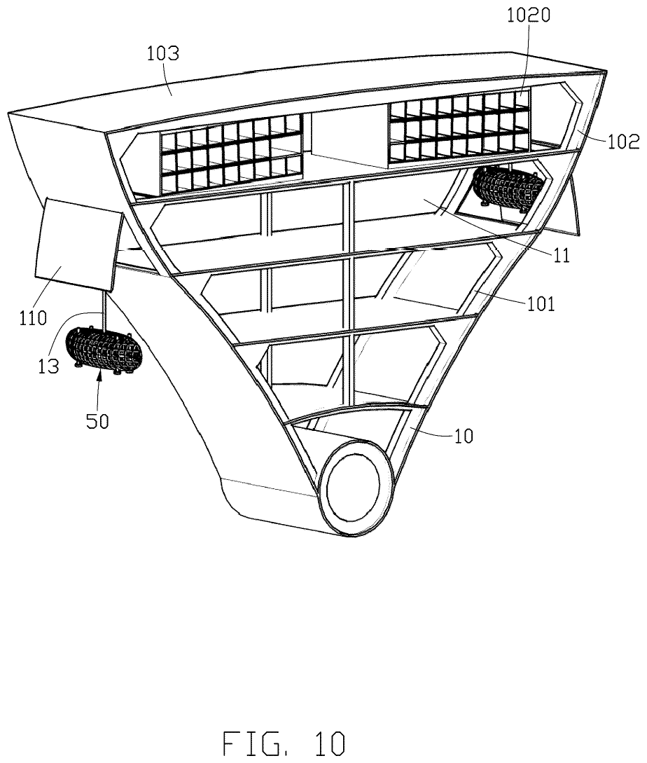

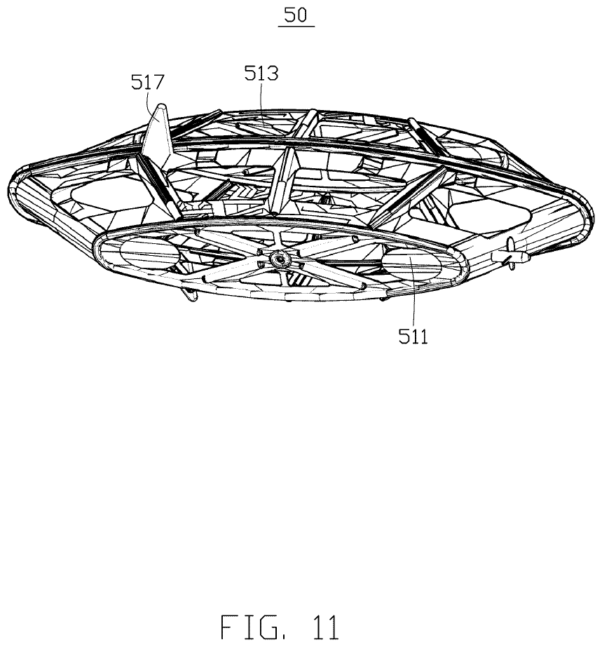

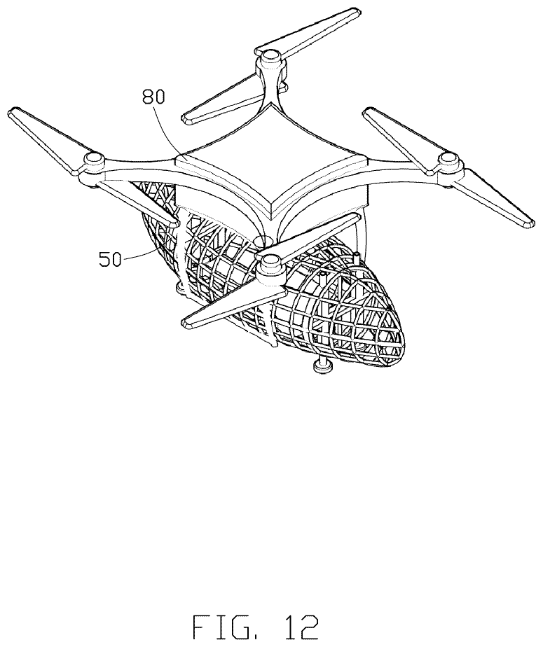

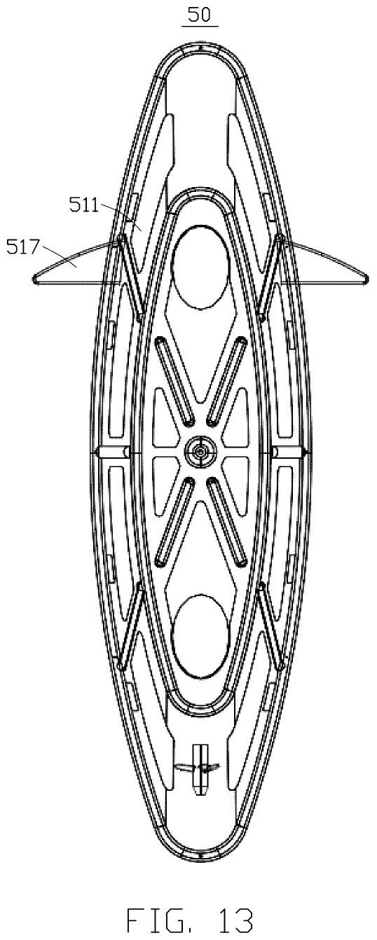

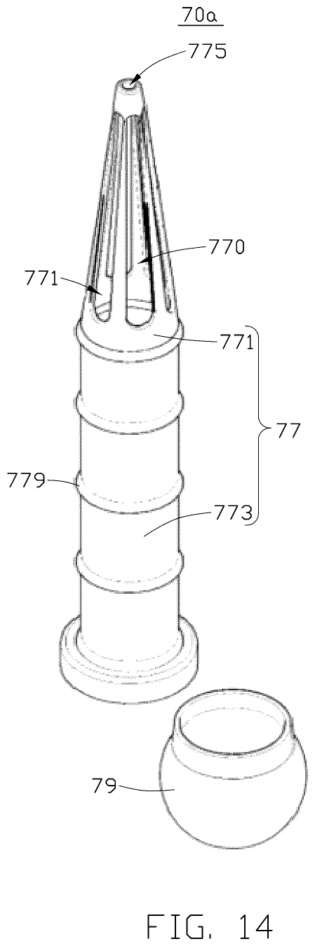

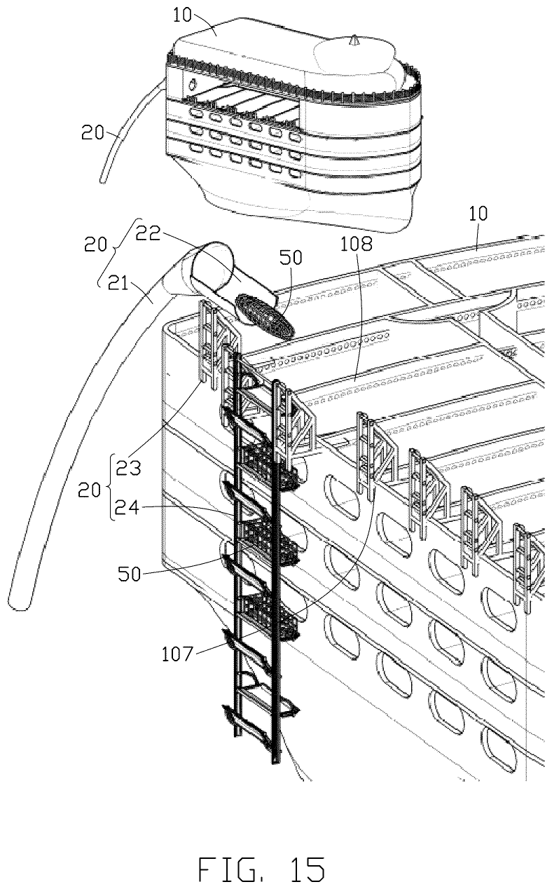

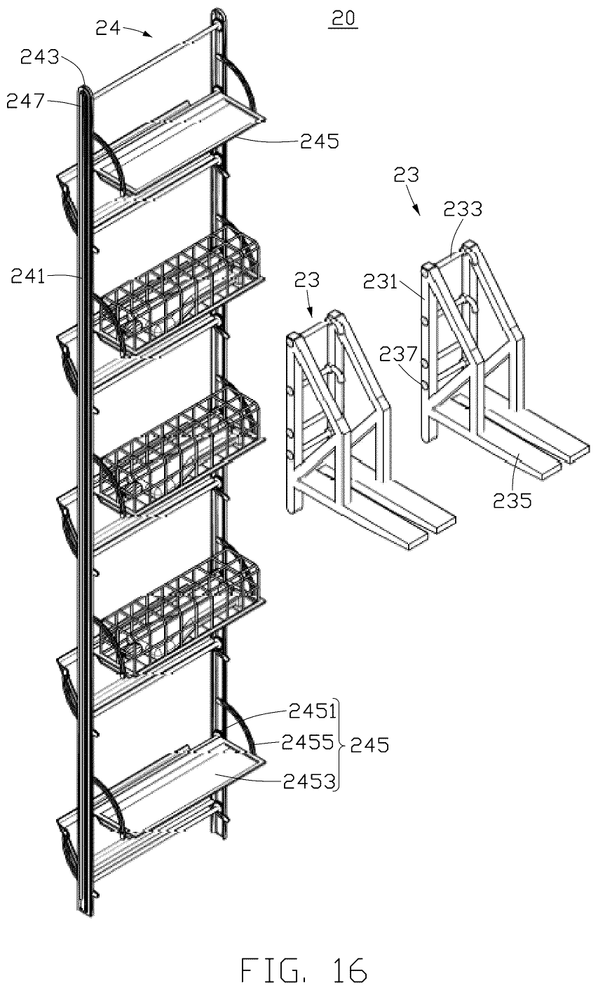

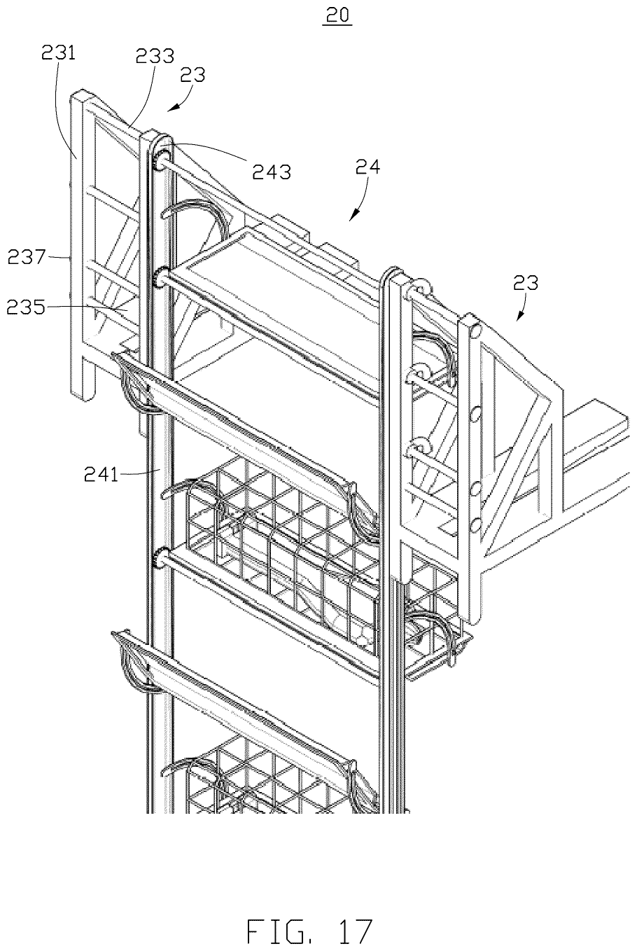

FIG. 3 is a diagram showing a structure of the casing body of the sea burial coffin shown in FIG. 2.

FIG. 4 is a diagram showing a structure of the lifting mechanism of the sea burial coffin shown in FIG. 2.

FIG. 5 is a diagram showing a structure of a counterweight structure of the sea burial system according to the first embodiment.

FIG. 6 is a diagram showing a structure of the counterweight structure of the sea burial system according to an alternative embodiment.

FIG. 7A, FIG. 7B, FIG. 7C and FIG. 7D are diagrams showing a structure of a deflation mechanism of the sea burial system in four states according to the first embodiment.

FIG. 8 is a perspective view of a sea burial system according to a second embodiment of the present disclosure.

FIG. 9 is a perspective view of a sea burial coffin of the sea burial system according to the second embodiment of the present disclosure.

FIG. 10 is a partial cross-sectional view of an application example of the sea burial system according to a third embodiment of the present invention.

FIG. 11 is a diagram showing a structure of a sea burial coffin of the sea burial system according to the third embodiment of the present disclosure.

FIG. 12 is a diagram showing the sea burial coffin transported by an aircraft.

FIG. 13 is a bottom view of the sea burial coffin shown in FIG. 11.

FIG. 14 is a diagram of a deflation mechanism according to a fourth embodiment of the present disclose.

FIG. 15 is a diagram showing a structure of a sea burial system according to a fifth embodiment of the present disclosure.

FIG. 16 is an exploded view showing a structure of a transmission mechanism shown in FIG. 15.

FIG. 17 is a diagram showing the structure of the transmission mechanism shown in FIG. 16.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

### First Embodiment

As shown in FIG. 1, a first embodiment of the present disclosure provides a sea burial system 100 for loading a corpse and transporting the corpse to specific coordinates on the waterbed or seabed, so that organisms in the water can decompose the corpse, thereby effectively relieving the cremation pressure.

The sea burial system 100 includes a transportation device 10, a music player 30, and a coffin 50. Both the music player 30 and the coffin 50 are detachably attached to the transportation device 10. The transportation device 10 is used to accommodate the corpse and family members of the corpse and transport the corpse to a location where the corpse falls into the water, the coffin 50 is configured to receive the corpse, and the music player 30 is configured for playing music to comfort the family members of the corpse or playing life stories of the corpse.

When the coffin 50 attaches to the transportation device 10 and the family members of the corpse walk onto the transportation device 10, the music player 30 starts playing music. Meanwhile, the transportation device 10 sails on a water surface, allowing the family members to mourn the corpse. Once the transportation device 10 arrives at the specific coordinates, the coffin 50 is detached from the transportation device 10 and is sunk into the water.

The transportation device 10 may be a boat, and includes a mourning area 11, a mounting rod 13, and a landing plate 15. The mourning area 11 defines a walking path for people who wants to express condolences, (e.g. his relatives or friends), to walk and mourn the corpse, the mounting rod 13 is configured to hang the coffin 50. The landing plate 15 is configured to attach the land and the mourning aera 11, thereby allowing the family members to walk to the mourning area 11 from the land through the landing plate 15.

A hollow structure is formed in a center of the mourning area 11, the hollow structure is configured to form a receiving hole 101. A middle portion of the mounting rod 13 is accommodated above the receiving hole 101, and both ends of the mounting rod 13 are fixed to a bottom surface of the mourning area 11, so that the coffin 50 is capable of sinking into the water through the receiving hole 101.

A crane is installed on the mourning area 11, which is provided with a hook. The coffin 50 is suspended on the middle portion of mounting rod 13 through the hook. When the corpse is received in the coffin 50 and then the coffin 50 is suspended on the mounting rod 13, the family members can walk onto the mourning area 11 via the landing plate 15, and then the transportation device 10 sails on the water surface and arrives at the specific coordinates, the coffin 50 can be lifted by the hook of the crane and falls into the water through the receiving hole 101. In some other embodiments, the transportation device 10 can be other transportation equipment as long as it can transport the coffin 50 from the land to the water surface and sink the coffin 50 to the specific coordinates on the waterbed or seabed.

A positioning mechanism 40 is fixedly accommodated on the mourning area 11 and configured for positioning specific coordinates of the transportation device 10. Therefore, when the specific coordinates where the corpse is to be sunk to the waterbed or the seabed is determined, the transportation device 10 sails on the water surface to reach the specific coordinates, allowing the corpse detaching from the transportation device 10 and sinking into the water. In this embodiment, the positioning mechanism 40 is a global positioning system.

As shown in FIG. 2 and FIG. 3, the coffin 50 includes a coffin body 51 and two pairs of lifting mechanisms 53, each pair of lifting mechanism 53 penetrates the coffin body 51 and protrudes from a top end of the coffin body 51 and a bottom end of the coffin body 51, and a top end of each lifting mechanism 53 is fixedly connected to the coffin body 51. When the coffin body 51 sinks into the water, a bottom end of the lifting mechanism 53 contacts with the waterbed, and the lifting mechanisms 53 is partially moved upward by a gravity of the coffin 50, so that the coffin body 51 is separated into two portions, and the corpse 50 in the coffin 50 contacts with microorganisms in the water and is decomposed by the microorganisms.

In this embodiment, the coffin body 51 is an oval-shaped boat, and the coffin body 51 has a hollowed-out grid structure. In detail, the coffin body 51 includes a first rib 50a, a pair of second ribs 50b, multiple pairs of third ribs 50c, and multiple fourth ribs 50d. The first rib 50a is arc-shaped and disposed at a bottom end or a top end of the coffin 50. Both ends of each second rib 50b are connected to two ends of the first rib 50a, and the pair of second ribs 50b is positioned on both sides of the first rib 50a. Multiple pairs of third ribs 50c and the pair of second ribs 50b are arranged side by side and spaced apart, and each pair of third ribs 50c is spaced between the first rib 50a and the pair of second ribs 50b, each third rib 50c has two opposite ends to connected to the first rib 50a. The multiple fourth ribs 50d intersect with each third rib 50c, the first rib 50a and the pair of second rib 50b, two adjacent fourth ribs 50d are arranged side by side and spaced apart, and both ends of each fourth rib 50d are connected to the second ribs 50b. Therefore, the first rib 50a, one third rib 50c, and two adjacent fourth ribs 50d, or two adjacent third ribs 50c and two adjacent fourth ribs 50d, or each second rib 50b, one third rib 50c adjacent to the second rib 50b, and two adjacent fourth ribs 50d cooperate to form a grid 50e.

The coffin body 51 includes multiple grids 50e, each grid 50e is in air communication with an external environment and an internal environment of the coffin 50. Therefore, when the coffin 50 comes into contact with water, the water can quickly permeate into the coffin 50 and soak the corpse, allowing the corpse to be rapidly immersed in water.

The coffin body 51 includes a casing body 511 and a cover 513, an interior of the casing body 511 is hollow to form a receiving space for receiving the corpse and some daily items of the corpse. The receiving space is in air communication with each grid 50e.

Two pairs of fixing rods 515 are received in the receiving space and arranged side by side along a length direction of the coffin 50. The two pairs of fixing rods 515 divide the receiving space into three spaces, and the three spaces are arranged side by side along the length direction of the coffin 50, the corpse can be received in a space between the two pairs of fixing rods 515. Each pair of fixing rods 515 corresponds to a pair of lifting mechanisms 53. Each pair of fixing rods 515 protrudes from a bottom surface of the casing body 511 toward the cover 513. Two fixing holes are defined on each pair of fixing rods 515 and configured to receive each pair of lifting mechanism 53. The top end of each lifting mechanism 53 is fixedly connected to the cover 513, and the bottom end of each lifting mechanism 53 passes through each fixing hole and protrudes from the bottom of the casing body 511. When the coffin 50 sinks into water, the bottom end of each lifting mechanism 53 contacts the waterbed or the seabed to support the coffin 50 on the underwater plane.

As shown in FIG. 2, an airbag 5131 with an air pipe is installed at a center of a top end of the casing body 513. When the airbag 5131 is filled with air through the air pipe, the coffin body 51 does not tilt or fall due to a water flow direction when floating underwater, and the airbag 5131 can also assist the two pairs of lifting mechanisms 53 to separate the casing body 511 and the cover 513.

As shown in FIG. 4, each lifting mechanism 53 includes a connecting column 531, a pneumatic rod 533, and a built-in ejection mechanism, the built-in ejection mechanism may be a spring plunger 535. A groove is defined in the connecting column 531, and the spring plunger 535 and the pneumatic rod 533 are both received in the groove. An end of the spring plunger 535 is fixed to a bottom surface of the connecting column 531, and another end of the spring plunger 535, provided with a spring, is connected to the pneumatic rod 533. When the spring plunger 535 is subjected to gravity from the coffin body 51, the spring of the spring plunger 535 rebounds and moves to the pneumatic rod 533 toward the cover 533. An end of the pneumatic rod 533 away from the spring plunger 535 is fixedly connected to the cover 513. When the coffin body 51 sinks to the water and contacts with the waterbed or the seabed, the pneumatic rod 533 is subjected to gravity of the coffin body 51, causing the spring of the spring plunger 535 to rebound, and the pneumatic rod 533 to push upward, thereby separating the cover 513 from the casing body 511. Living organisms in the seabed or the waterbed, such as sea fish, shrimp and microorganism, can enter the casing body 511 through the grid 50e to decompose and feed on the corpse.

Referring to FIG. 2 to FIG. 5, an anchor 537 attaches to an outer bottom of the connecting column 531, and a bottom end of the anchor 537 is configured to pierce into the seabed or the waterbed. A plurality of wedges connect to an outer circumference of the anchor 537, and a counterweight block 539 installs on a middle portion of the connecting column 531. The anchor 537, the wedge, and the counterweight block 539 cooperate to assist the coffin body 51 to be positioned rapidly and stably at a predetermined location on the seabed or waterbed.

As shown in FIG. 6, in an alternative embodiment, a counterweight structure 538 attaches to a bottom end of the casing body 511. The counterweight structure 538 includes a bag and cement received within the bag. When the cement contacts with water, it solidifies to form a cement block, and a weight of the cement block is 1.6 to 1.8 times that of the cement. Therefore, the coffin body 51 can rapidly sink to the bottom of the sea under a gravity force of the cement block.

As shown in FIG. 7, a deflation mechanism 70 is wound around an abdomen 200 of the corpse. When gas produced by bacterial decomposition causes the corpse's body to bloat, the deflation mechanism 70 deforms and punctures the abdomen 200 of the corpse, allowing the gas to escape from the abdomen 200 of the corpse. Subsequently, aquatic microorganisms and marine fish decompose the organs within the abdomen 200 of the corpse.

As shown in FIG. 7A, the deflation mechanism 70 includes two telescopic belts 71, a rear belt 72 and a scissor 73. The two ends of each telescopic belt 71 are respectively connected to the rear belt 72 and the scissor 73. The rear belt 72 is fixed to a rear waist of the corpse, and the scissor 73 is disposed at the abdomen 200 of the corpse, and the two telescopic belts 71 are located on both sides of the waist of the corpse. Each telescopic belt 71 has elasticity and is capable of deforming and extending when the deflation mechanism 70 is in a usage state. As shown in FIG. 7B, when the corpse is not inflated, two blades of the scissor 73 are arranged parallel to the rear belt 72. As shown in FIG. 7C, when the abdomen 200 of the corpse is inflated by gas, each telescopic belt 71 starts to deform and extend, and the two blades of the scissor 73 start to be arranged at a certain angle. As shown in FIG. 7D, when the abdomen 200 of the corpse is inflated to a certain extent, the two telescopic belts 71 drive the blades to face and pierce into the abdomen 200 of the corpse, so that the gas in the abdomen 200 of the corpse escapes, and internal organs of the corpse are exposed, accelerating the decomposition of the corpse's body by organisms in the water. In this embodiment, a material of each telescopic belt 71 may be a decomposable biological-based polymer material, such as polyhydroxyalkanoate (PHA).

Referring to FIG. 1, it should be noted that the coffin 50 is made of degradable materials or recyclable materials. When the coffin 50 is made of recyclable materials, the coffin 50 is made of 316L stainless steel. Alternatively, rapid rusting treatment can be implemented on the coffin 50 before use. For example, spraying adhesive potassium iodide powder or hydrogen peroxide on an inner wall of the coffin body 51, or heating the coffin body 51 by fire, and then cooling it, and next pouring it in salt water, achieving to accelerate decomposition of the coffin 50.

In this embodiment, the corpse not only includes human corpse but also animal carcasses. In addition, the coffin 50 can be used not only for water burial but also for inhumation. Since the coffin 50 is made of degradable materials, it can be easily decomposed by microorganisms in the soil. In some other embodiments, the coffin 50 can be formed by a bending and folding process. As time goes by, both the corpse and the coffin 50 are completely decomposed by marine organisms, making the natural burial method environmentally friendly. The sea burial system 100 of the present disclose combines a counterweight structure 538 and an anchor 537, so that the coffin 50 can sink to the bottom of the waterbed instead of floating on the water surface. Moreover, the sea burial system 100 integrates a music player 30 and a positioning mechanism 40 to achieve precise placement of the corpse and emotional memory of the family members of the corpse.

It can be understood that the coffin 50 may be covered with a protective cover, and the coffin 50 may be provided with clothes, quilts and the like for the corpse to use. and the protective cover, the quilt and the clothes are all made of hydrolysable materials.

### Second Embodiment

Referring to FIG. 8 and FIG. 9, a difference between this embodiment and Embodiment 1 lies in a structure and an application scenario of the coffin 50. In this embodiment, a cross-sectional shape of the coffin body 51 is circular, and a plurality of spacer plates 5113 protrudes from the bottom surface of the casing body 511 toward the cover 513. The receiving space of the coffin body 511 is divided into multiple small spaces by the plurality of spacer plates 5113, and each small space is configured to receive a corpse, so that the coffin body 511 can receive multiple corpses at one time, which is suitable for holding large-scale funerals during major epidemics or wars.

The coffin body 51 may be applied to a terrestrial ecological waterway 90, and a microbial groove 91 is defined at a bottom of the terrestrial ecological waterway 90 and configured to receive a plurality of microorganisms. When the coffin body 51 sinks into the terrestrial ecological waterway 90, the coffin body 51 can sink into the area close to the microbial groove 91, so that the multiple corpses can be decomposed by microorganisms more quickly.

### Third Embodiment

Referring to FIG. 10 and FIG. 11, a difference between this embodiment and Embodiment 1 lies in a structure of the transportation device 10. The transportation device 10 is a marine ship or a waterside pier funeral home. Specifically, the transportation device 10 further includes a main area 101, a receiving area 102 and a deck area 103.

The main area 101 is used for rest and activities of the personnel on the ship. The mourning area 11 is used for mourners to pay their respects to the corpse. Two cabin doors 110 are provided on both sides of the mourning area 11, and the music player 30 is attached to an inner side wall of each cabin door 110. The deck area 103 is configured to accommodate a lifting equipment or an aircraft 80, such as drones. And the deck area 103 has a top opening to allow the aircraft 80 to fly skyward and toward the specific coordinates where the coffin 50 is to be sunk into the water.

Multiple freezers 1020 are received in the receiving area 102 to store at least one corpse. Operational spaces are formed on both sides of the freezers 1020 to facilitate grooming of the corpse. A mounting rod 13 attaches to each cabin door 110 and configured for hanging the coffin 50.

In the floor of the receiving area 102, corresponding to the mounting rod 13, a containment hole penetrates through the receiving area 102 and the mourning area 11, allowing the coffin 50 to pass through to the mourning area 11. When the at least one cabin door 110 is opened, the coffin 50 is hung by the mounting rod 13 and located at a side of the opening cabin door 110. After the family members of the corpse have paid their respects in the mourning area 11, lifting equipment can lift the coffin 50 from the mounting rods 13 and slowly take it to specified coordinates on the seabed.

Referring to FIG. 12, alternatively, the lifting equipment can transport the coffin 50 to the deck area 103, where the aircraft 80 can lift up the coffin 50 and fly to a specified sinking point before lowering it to the seabed.

Referring to FIG. 13, in a same or different embodiment, the coffin 50 is shaped like a flying saucer, and a pair of wind panels 517 are symmetrically arranged at two opposite sides of the casing body 511 and configured to assist the coffin 50 move stably to the water.

### Fourth Embodiment

Referring to FIG. 14, a difference between this embodiment and Embodiment 1 lies in a structure of the deflation mechanism 70a. The deflation mechanism 70a may be a deflation tube for discharging the gas inside the corpse's body. The deflation tube includes a main tube 77 and a plug 79. The main tube 77 is elongated and has a hollow structure to define a cavity 770.

The main tube 77 includes a first part 771 and a second part 773. The first part 771 is cone-shaped and is used for inserting into an anal canal of the corpse. A vent hole 775 is defined on a side of the first part 771 away from the second part 773 and is used to receive the air generated inside the corpse's body after bacterial reproduction. A side wall of the first part 771 is provided with strip-shaped air vents 777. The air vents 777, the cavity 770, and the vent hole 775 are in air communication with each other. Therefore, the air inside the corpse's body is discharged from the vent hole 775 and then out of the corpse's body through the air vents 777 and the cavity 770.

A plurality of protrusions 779 protrudes from an outer side wall of the main tube 77. The plurality of protrusions 779 are used to fit on both sides of the corpse's anal canal to prevent the deflation tube from detaching from the corpse. The plurality of protrusions 779 are arranged side by side and spaced apart along a length direction of the main tube 77.

The second part 773 is cylindrical shape. A side of the second part 773 away from the first part 771 protrudes outward to form a clamping part, an opening is defined on the clamping part and used to connect to the plug 79, the opening is in air communication with the cavity 770. After the deflation tube is inserted into the corpse's body, the gas inside the corpse's body is discharged from the vent hole 775 and flows to the vent 777 and the cavity 770, so that a part of the gas is discharged from the air vents 777, and another part of the gas passes through the cavity 770 and pushes the plug 79 outward, causing the plug 79 to detach from the main tube 77. Then, seawater can enter the cavity 77 through the opening and flow into the corpse's body through the vent hole 775, accelerating the sinking of the corpse to the seabed. In this embodiment, the deflation tube is made of a degradable material, such as a starch-based composite material formed by mixing starch and polylactic acid.

### Fifth Embodiment

Referring to FIG. 15 and FIG. 16, in this embodiment, the transportation device 10 is a ship and a transmission mechanism 20 is detachably installed on the ship. One end of the transmission mechanism 20 is connected to the ship, and another end of the transmission mechanism 20 extends into the seawater or be close to the water surface, stably transmitting the coffin 50 into the seawater.

The transmission mechanism 20 includes a transmission cylinder 21 and a contact plate 22 connected to one bottom end of the transmission cylinder 21. An interior of the transmission cylinder 21 is hollow to define an accommodating space, and both ends of the transmission cylinder 21 are provided with open ports, respectively. Each open port is in air communication with the accommodating space. The two open ports are respectively used for receiving and discharging the coffin 50, allowing the coffin 50 to be slowly lowered into the seawater through the transmission cylinder 21.

The transmission cylinder 21 is strip-shaped. One end of the transmission cylinder 21 close to the contact plate 22 is arranged on the ship, and an outer side wall of the transmission cylinder abuts against a side wall of a top opening of the ship. Another end of the transmission cylinder 21 away from the contact plate 22 extends into the seawater, so that a part of the transmission cylinder 21 is located in the seawater. When the coffin 50 is placed in the accommodating space of the transmission cylinder 21, the coffin 50 can freely slide into the seawater along the transmission cylinder 21.

The contact plate 22 is connected to an outer side wall of one of the open ports and is used for placing the coffin 50.

After the family members of the corpse have paid their respects on the ship, the transmission cylinder 21 and the contact plate 22 are installed on the ship. Firstly, The coffin 50 is transported to the contact plate 22 by a lifting equipment and placed on the contact plate 22. Then, the coffin 50 is pushed toward the open port and slowly fall into the seawater through the accommodating space of the transmission cylinder 21.

The transmission cylinder 21 is foldable and can be stored inside the ship for easy carrying and use.

Referring to FIG. 16 and FIG. 17, in an alternative embodiment, the transmission mechanism 20 comprises an automatically conveyor belt arranged at the transportation device 10, an end of the automatically conveyor belt is coupled to the transportation device 10 and the other end is located above the water surface. Especially, the automatically conveyor belt includes two mounting frames 23 and a bracket 24 connected between the two mounting frames 23.

Each mounting frame 23 comprises two mounting plates 231, a connecting rod 233, and two connecting plates 235. Wherein, the two mounting plates 231 are arranged and spaced apart and connected to each other through a connecting rod 233, and the two connecting plates 235 respectively bend and extend from one side of the mounting plate 231 and can be inserted into an opening 107 on the ship. The two connecting plates 235 are spaced apart and cooperatively engaged with a connecting plate 108 of the ship, allowing the two mounting frames 23 to be stably connected to the ship.

Multiple gears 237 are installed on two sides of the two mounting plates 231 facing away from each other. The multiple gears 237 are arranged side by side and spaced apart along a length direction of the mounting plate 231, and an outer perimeter from each gear 237 protrudes from the mounting plate 231, and one of the gears 237 is located at a top end of the mounting plate 231. The multiple gears 237 are connected to a motor, so that the multiple gears 237 are driven to rotate under a drive of the motor.

The bracket 24 includes a support frame 241, a chain 243, and a receiving portion 245, the chain 243 is slidably accommodated on the support frame 241, the receiving portion 245 connects to the chain 243, and is located on one side of the support frame 241, and moves simultaneously with the chain 243.

The support frame 241 is ring-shaped and is mounted on a sidewall of the ship and cooperates with the two mounting frames 23. After the support frame 241 is mounted on the ship, one end of the support frame 241 is close to the ship, and another end of the support frame 241 extends toward the water or the sea. The support frame 241 includes two rods arranged in parallel and spaced apart, each rod including a first side and a second side opposite to the first side. The first side is used to connect with each mounting frame 23, and the second side is used to connect the receiving portion 245.

The chain 243 is ring-shaped and is slidably mounted on an outer sidewall of each rod, with both ends protruding from the first side and the second side, thereby meshing with the receiving portion 245 and the multiple gears 237. A guide groove 247 is defined in the first side of each rod. The multiple gears 237 are slidably received in the guide groove 247 and mesh with the chain 243, so that when the multiple gears 237 rotate, the chain 243 rotates simultaneously.

The receiving portion 245 connects to the chain 243. The receiving portion 245 includes two pulleys 2451, a receiving plate 2453, and two connecting arms 2455. The receiving plate 2453 includes a recess area for accommodating the coffin 50. A middle part of each side of the receiving plate 2453 is fixedly connected to each connecting wall 2455, and two corner ends of the receiving plate 2453 are connected to the pulleys 2451. The pulleys 2451 are slidably received in the second side of the rod and mesh with an inner sidewall of the chain 243 protruding from the second side. Thus, when the chain 243 moves along a length direction of the rod, the pulleys 246 slide simultaneously along the length direction, allowing the coffin 50 accommodated in the recess area to be transported from the ship to the water surface.

One end of the connecting arm 2455 is fixed to the chain 243, and another end of the connecting arm 2455 is connected to a middle part of the receiving plate 2453, thereby ensuring the stable placement of the coffin 50 on the receiving plate 2453.

When a wind force on the sea is relatively strong and the coffin 50 cannot slide to the specified coordinates within the specified seabed, the ship can sail to the specified target, and the mounting frame 23 is inserted into the opening 107 of the ship, and the bracket 24 is installed between the two mounting frames 23. When the multiple gears 237 are driven to rotate, the chain 243 rotates synchronously, and the receiving portion 245 is synchronously driven to move linearly from a top end of the rod toward a bottom end of the rod. When the receiving portion 245 moves to the bottom end of the rod along with the chain 243, the chain 243 continues to rotate and moves from one side of the rod to another side of the rod, at this time, the receiving portion 245 also moves synchronously and flips. During flipping, the coffin 50 in the recess area detaches from the receiving plate 2453 and falls into the specified coordinates in the sea. Then, after flipping, the receiving portion 245 moves linearly from the bottom end of the rod toward the top end of the rod together with the chain 243.

It can be understood that a limit bearing for restricting a movement direction of the receiving portion 245 is installed on the bottom end of the rod. Meanwhile, the multiple gears 237 may not connects to the motor but move relying on the gravity of the coffin 50 and the corpse 200, thereby driving the chain 243 and the receiving portion 245 to slide synchronously. When the coffin 50 is placed in the recess area near the top end of the rod, under the gravity of the coffin 50 and the corpse 200, the chain 243 and the receiving portion 245 move synchronously and toward the bottom end of the rod and the water surface until approaching the water surface. Due to an inertial effect of gravity and a limiting effect of the limit bearing, when the receiving portion 245 moves to the bottom end of the rod, the coffin 50 will be thrown out and sink into the water.

What the claim is:

1. A sea burial system, comprising:
a coffin, defining a receiving space to receive at least one corpse,
a transportation device, configured to transport the coffin to a designated location on a water surface, and
a transmission mechanism, fixed to the transportation device, and configured for transmitting the coffin from the transportation device to the designated location;
wherein the coffin comprises a coffin body for holding the corpse, and at least a part of the coffin body is arranged as a hollow grid structure.

2. The sea burial system according to claim 1, wherein the coffin body comprises a casing body and a cover attached to the casing body, and the coffin further comprises a lifting mechanism attached to the casing body and the cover, the lifting mechanism is configured to lift up the cover, and separate the cover from the casing body, and the hollow grid structure is arranged on at least one of the casing body and the cover.

3. The sea burial system according to claim 2, wherein the lifting mechanism includes a pneumatic rod and a connecting column, the pneumatic rod is received in an inner space of the connecting column, and has a first end and a second end opposite to the first end; the first end of the pneumatic rod is disposed to extend beyond a bottom surface of the casing body and the second end of the pneumatic rod is engaged with the cover;
when the first end of the pneumatic rod connected to the casing body is subjected to an external force directed from the casing body toward the cover, the second end of the pneumatic rod pops out of the inner space of the connecting column under an action of a built-in ejection mechanism which is located between an end of the connecting column and the first end of the pneumatic rod, thereby driving the separation of the cover from the casing body.

4. The sea burial system according to claim 2, wherein a counterweight structure attaches to the casing body, and the weighting mechanism comprises a bag filled with cement, which hardens upon contact with water.

5. The sea burial system according to claim 1, further comprising a deflation mechanism attached to the corpse and configured to expel gas from the corpse's body into an external environment.

6. The sea burial system according to claim 5, wherein
the deflation mechanism comprises at least one telescopic belt and a scissor attached to two ends of the at least one telescopic belt, and the at least one telescopic belt and the scissor cooperate to wound around an abdomen of the corpse.

7. The sea burial system according to claim 5, wherein the deflation mechanism comprises an elongated deflation tube, and the deflation tube comprises a first part having a sharp end and a second part connected to the first part, an inner space of the first part is air communicated with an inner space of the second part so as to form a gas deflection channel, the gas generated by the corpse is discharged to the external environment via the sharp end and the gas deflection channel in order.

8. The sea burial system according to claim 1, wherein the transmission mechanism comprises a transmission cylinder and a contact plate connected to the transmission cylinder, the transmission cylinder comprises a cylinder connection portion configured to connect to the contact plate and the transportation device, and a cylinder transmission portion attached to the cylinder connection portion, and the cylinder transmission portion cooperates with the cylinder contact plate to form a transmission path between the cylinder connection portion and the water surface for allowing the coffin to be transmitted on the transmission path.

9. The sea burial system according to claim 1, wherein the transmission mechanism comprises an automatically conveyor belt arranged at the transportation device, an end of the automatically conveyor belt is coupled to the transportation device and the other end is located above the water surface.

10. The sea burial system according to claim 3, wherein an airbag attaches to the cover and configured to make the coffin to remain balance on the water surface, the airbag comprises an air pipe, and the airbag is capable of assisting the cover to be separated from the casing body when the airbag is inflated via the air pipe.

11. The sea burial system according to claim 1, wherein a pair of wind panels are symmetrically arranged at two opposite sides of the casing body and configured to assist the coffin move stably to the water.

12. The sea burial system according to claim 1, wherein the transportation device may be a marine ship, or a boat, or an aircraft.

13. The sea burial system according to claim 1, wherein a music player is attached to the transportation device.

14. The sea burial system according to claim 1, wherein the transportation device comprises a location where the coffin is located and a mourning area surrounding the location.

15. The sea burial system according to claim 1, wherein a global positioning system attaches to the transportation device or the coffin to locate a position of the transportation device and assist the transportation device in positioning to specific coordinates where the coffin is to sink into the water.

16. A sea burial coffin, comprising:
a coffin body configured to receive at least one corpse,
a hydrolysable protective cover covered on an outer surface of the coffin body;
wherein at least a portion of the coffin body is arranged as a hollow grid structure.

17. The sea burial coffin according to claim 16, wherein the coffin body comprises a casing body and a cover attached to the casing body, and the coffin further comprises a lifting mechanism attached to the casing body and the cover, the lifting mechanism is configured to lift up the cover, and separate the cover from the casing body, and the hollow grid structure is arranged on at least one of the casing body and the cover.

18. The sea burial coffin according to claim 17, wherein the lifting mechanism includes a pneumatic rod and a connecting column, the pneumatic rod is received in an inner space of the connecting column, and has a first end and a second end opposite to the first end; the first end of the pneumatic rod is disposed to extend beyond a bottom surface of the casing body and the second end of the pneumatic rod is engaged with the cover;
when the first end of the pneumatic rod connected to the casing body is subjected to an external force directed from the casing body toward the cover, the second end of the pneumatic rod pops out of the inner space of the connecting column under an action of a built-in ejection mechanism which is located between an end of the connecting column and the first end of the pneumatic rod, thereby driving the separation of the cover from the casing body.

19. The sea burial coffin according to claim 17, wherein a counterweight structure attaches to the casing body, the weighting mechanism comprises a bag filled with cement, which hardens upon contact with water.

20. The sea burial coffin according to claim 17, wherein one of the casing body and the cover comprises a plurality of first ribs and a plurality of second ribs intersected with the first ribs, two adjacent first ribs and two adjacent second ribs are spaced apart and cooperate to form multiple grids.
